(19) United States
(12) Patent Application Publication
(10) Pub. No.: US 2009/0097459 A1
(43) Pub. Date: Apr. 16, 2009

(54) METHOD FOR WAN ACCESS TO HOME NETWORK USING ONE TIME-PASSWORD

(75) Inventors: Gert Magnus Jendbro, Staffanstorp (SE); Patrik Seger, Malmo (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/876,032

(22) Filed: Oct. 22, 2007

Related U.S. Application Data
(60) Provisional application No. 60/979,877, filed on Oct. 15, 2007.

(51) Int. Cl. H04Q 7/24

(52) U.S. Cl. 370/338

(57) ABSTRACT

A mobile device is configured to securely access a trusted network over of wide area network. The mobile device includes a communication interface, a processor, and a memory. The mobile device connects to the trusted network via a local access point in the trusted network at a first point in time, receives a password list containing a plurality of one-time passwords from the trusted network while the mobile device is connected to the trusted network via the local access point, stores the password list in memory, subsequently connects remotely to the trusted network over a wide area network, and sends a selected one-time password from the password list to access network resources in the trusted network.

### RELATED APPLICATION

This application claims the benefit of U.S. Provisional Patent Application 60/979,877, filed Oct. 15, 2007, which is incorporated herein by reference.

### BACKGROUND

The present invention relates generally to communications over wide area networks and, more particularly, to remote access to a home network from mobile devices using one-time passwords.

It will soon be common for users to connect remotely to their home networks from mobile devices, such as cellular telephones, personal, digital assistants, and laptop computers, in order to access files stored at home and to share multimedia content such as pictures, movies, music, etc. When remotely accessing a home network, the user may be required to provide a valid user name and password to authenticate the user's identity and gain access to the home network. A problem with this authentication approach is that some users may choose static passwords that remain unchanged for years. Another problem is that these passwords may sometimes be exchanged in clear text over an insecure network. Thus, a malicious party that discovers the password may use it to illegally gain access to the user's home network.

### SUMMARY

The present invention provides a method of securely accessing a trusted network, such as a home network, over a wide area network from a mobile device using one-time passwords. The mobile device receives a list of one-time passwords while the mobile device is connected to the home network via a local access point or other secure connection. The mobile device stores the password list in memory in the mobile device. Subsequently, the mobile device connects remotely to the home network over a wide area network (WAN). To connect over the WAN, the mobile device sends a selected one-time password from the stored password list to the home network to authenticate itself to the home network. In the preferred embodiments, the mobile device sends a different one-time password to the home network each time the mobile device accesses the home network. Because the passwords are used only once, the passwords are rendered useless to a malicious third party that may somehow discover the password.

### BRIEF DESCRIPTION OF THE DRAWINGS

FIG. 1 illustrates an exemplary communication network.

FIG. 2 illustrates an exemplary method for remotely accessing a home network via a wide area network.

FIG. 3 illustrates an exemplary process for selecting passwords from a password list stored in memory.

FIG. 4 illustrates an exemplary mobile device for remotely accessing a home network via a WAN.

### DETAILED DESCRIPTION

The present invention will now be described with reference to the accompanying drawings, which illustrate embodiments of the invention. These embodiments are meant to illustrate the principles of the invention which may then be applied to other embodiments. Thus, the invention should not be construed as limited to the illustrated embodiments.

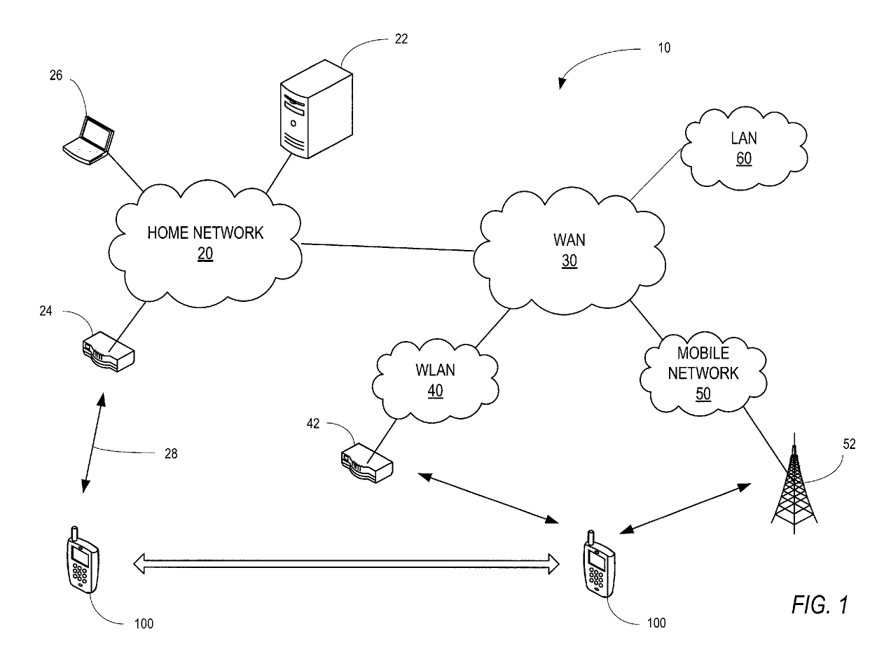

FIG. 1 illustrates an exemplary communication system 10 including a trusted network 20 connected to a wide area network (WAN) 30. In this example, the trusted network comprises the user's home network. The home network 20 may comprise, for example, a conventional local area network (LAN). WAN 30 may be a public network or private network. The Internet is one example of a public WAN. As will be described in further detail below, a mobile device 100 may access the home network via a local access point, or via the WAN 30.

In the illustrated embodiment, the home network 20 includes a home server (HS) 22 and a local wireless access point (WAP) 24, such as a wireless router. Those skilled in the art will appreciate that other home devices 26, such as home computers, televisions, digital video recorders/players, etc., may also be connected to the home network 20. Home server 22 may comprise a conventional computer that functions as a file server to share files and media content with other networked devices in the home network 20. In addition, the home server 22 may function as a firewall and provide authentication and access control to users attempting to access the home network 20 and/or network resources. The firewall, authentication, and access control functions, however, may be performed by a separate computer. Shared files and media content may be stored in the home network 20 in the home sever 22 and/or in other home devices 26. Shared files may be stored in a centralized file server (e.g., home server 22) or may be distributed among a plurality of home devices 26, including the home server 22.

The WAP 24 in the home network 20 provides wireless local access to mobile devices 100. The WAP 24 may, for example, comprises a wireless router based on the 802.11 family of standards. The WAP 24 may also employ other short-range wireless access technologies, such as Near Field Communication (NFC) or BLUETOOTH. As is known, these standards may use encryption to provide a secure communication channel 28 between the WAP 24 and mobile devices 100 that connect to the home network 20 via the WAP 24. WAP 24 may alternatively, comprises an infrared interface that provides a physically secure location-limited channel to the mobile device 100.

Wireless access to the WAN 30 may be provided by a variety of access technologies. For example, wireless access to the WAN 30 may be provided by a wireless local area network (WLAN) 40 having one or more local wireless access points 42. WLAN 40 may be based on the 802.11 (WiFi) and 802.16 (WiMax) family of standards. Also, wireless access may be provided by cellular networks 50 via one or more base stations 52. The cellular networks 50 may be based on a variety of access technologies, such GSM packet Radio Service (GPRS), Wideband Code Division Multiple Access (WCDMA), Orthogonal Frequency Division Multiplexing (OFDM), and the emerging Long-Term Evolution (LTE) standard. The mobile device 100 could also connect to WAN 30 through a wired connection, such as a LAN 60.

Mobile device 100 may access the home network 20 locally via a local access point, such as local WAP 24. The mobile device 100 may also physically connect to the home network 20, e.g., via a hub. However, there may be times when the mobile device 100 needs to connect remotely to the home network 20 via the WAN 30. In this case, mobile device 100 establishes a connection with the WAN 30 via WLAN 40, or via a mobile network 50. The mobile device 100 may then access the home network 20 through the WAN 30.

Typically, remote access to a home network 20 is secured by a password. In order to gain access, the mobile device 100 must supply a valid user name and password to authenticate itself to the home network 20. In some instances, the user name and password may be transmitted as clear text over the WAN 30. In other instances, the user name and password may be encrypted prior to transmission. In either case, an interloper could intercept the password and use it to illegally access the home network 20.

According to embodiments of the present invention, a password list containing a large number of one-time passwords is transferred to the mobile device 100 when the mobile device connects to the home network 20 via a local access point. Subsequently, when mobile device 100 connects to the home network 20 remotely through a WAN 30, the mobile device 100 uses one of the one-time passwords from the password list to authenticate itself and thereby gain access to the home network 20. Each password on the list is used only one time. Thus, a third party that intercepts or otherwise discovers one of the passwords will not be able to use the password again to gain access to the home network 20.

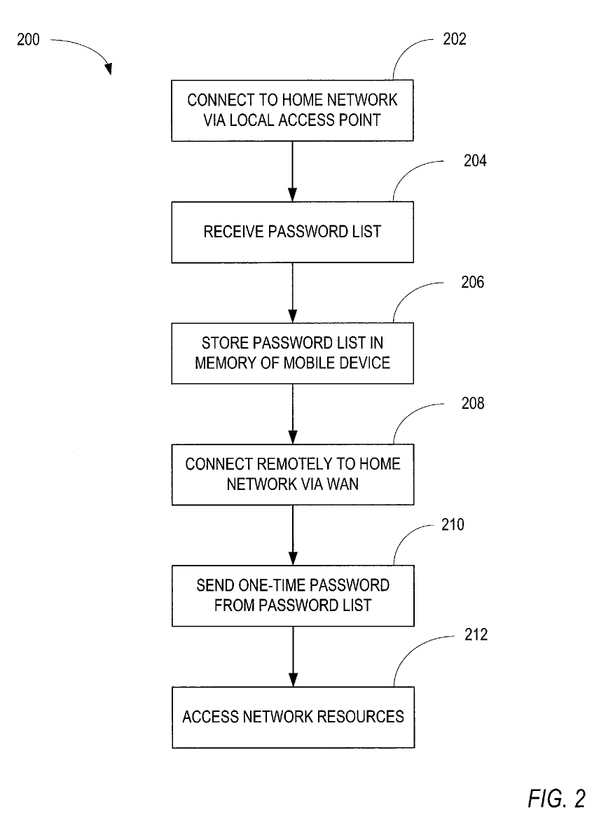

FIG. 2 illustrates an exemplary method 200 of remotely accessing a home network 20. The mobile device 100 at some point in time connects to the home network 20 via a local access point, such as local WAP 24 (block 202). While the mobile device 100 is connected to the home network 20, a password list containing a list of one-time passwords is transferred to the mobile device 100 (block 204). The password list may be provided, for example by the home server 22 or other entity within the home network 20 responsible for access control. The mobile device 100 stores the password list in its internal memory, and preferably in a secure memory device, such as a smart card (block 206). At some subsequent time, the mobile device 100 remotely connects to the home network 20 via the WAN 30 (block 208). When the mobile device 100 attempts to establish a remote connection to the home network 20, the home server 22, or other entity responsible for access control prompts the user to supply a password. In response to the password prompt, the mobile device 100 selects a password from the password list and sends the selected password to the home network 20 (block 210). In some embodiments, the mobile device 100 may send the password with its initial access attempt without an explicit prompt. Those skilled in the art will appreciate that each password in the password list is used only one time and then discarded. Thus, the mobile device 100 provides a different password each time it remotely connects to the hone network 20. An authentication agent in the home network (e.g., home server 22) verifies that the submitted password is valid. If a valid password is sent, the mobile device is granted access to the home network 20 and may access network resources (block 212).

Those skilled in the art will appreciate that some network resources may also require a password for accessing such resources. For example, the home network 20 may include a file server where shared documents, video, and audio files are stored. The file server may require a valid password to access shared files and media content. A one-time password list may also be used to access such shared resources. When attempting to access a password protected network resource, the mobile device 100 may send a valid one-time password to the authentication agent for the resource to be allowed access. In some embodiments, a single authentication agent may be provided for all resources of the network and a single password list may be used for all resources, as well as for network access. In other embodiments, different password lists may be used for different network resources.

In some embodiments, a new password list may be provided to the mobile device 100 each time the mobile device 100 connects to the home network 20 via a local access point in order to improve security. In other embodiments, the password list may be valid only for a specific period of time (e.g., 24 hours or one week). In this case, a new password list may be provided the next time that the user connects after the expiration of some predetermined period of time. In other embodiments, the password list may be transferred upon request by the mobile device 100. Other triggers may also be used to update the password list. When a new password list is provided, the mobile device 100 and home network 20 will both discard the old password list.

The password list is preferably transferred to the mobile device 100 over an encrypted communication channel or physically secure communication channel in order to prevent interception by a malicious third party. The password list may be encrypted prior to sending the password list to the mobile device 100 depending on the desired level of security. For example, the password list may be encrypted with the user's public key or with a secret key known to both the home network 20 and mobile device 100. If the password list is encrypted prior to transmission to the mobile device 100, the communication channel does not necessarily need to be secure. Thus, the password list may in principle be transmitted to the mobile device 100 when the mobile device 100 is connected remotely, though such is not the preferred embodiment. If the password list is transferred over an encrypted channel or physically secure channel, it may be transmitted in clear text and then encrypted and stored in the internal memory of the mobile device 100. However, it is generally preferred to encrypt the password regardless of whether the communication channel is secure.

The mobile device 100 preferably stores the password list in encrypted form, and/or in a secure memory device, such as a smart card. When the password list is stored in encrypted form, it may be stored in memory that is not secure. In this case, the corresponding private key for decrypting the password list should itself be stored in a secure memory device, such as a smart card. Whether stored in encrypted form or stored in a secure memory device, the user may be required to provide a valid user name and password each time the user accesses the password list in case the mobile device falls into the hands of a third party.

When transmitting the one-time password to the home network 20 in order to access the home network 20 via the WAN 30, the mobile device 100 may encrypt the one-time password with a public key associated with the home network to further protect the password from discovery by a third party.

In some embodiments, the password list may comprise a random or pseudorandom sequence of bits. The bit sequence will typically be a long sequence in the order of 1 MBit (1,000,000) bits or more in length. The bits in the bit sequence may be a true random sequence generated from a true noise source or may be a pseudorandom sequence generated by a random sequence generator from a supplied seed. The passwords in this case would comprise a sequence of N bits selected from the random sequence in some predetermined manner. For example, the first password may comprise the first N bits, the second password the next N bits, etc. It is not necessary that the bits of the password be consecutive bits in the random bit sequence. Also, it is not necessary that the bits be selected from the start of the random bit sequence. The bits may be selected in any deterministic manner known to both the home network 20 and the mobile device 100. Thus, the bit selection process for selecting bits comprising the password may be a shared secret between the mobile device 100 and home network 20. Unless this secret is known, the password list is useless to any third party that may acquire the password list. The bit selection process may be provided to the mobile device 100 with the password list, or at some different time. In some embodiments the bit selection process may be changed at any time independently of the password list for additional security.

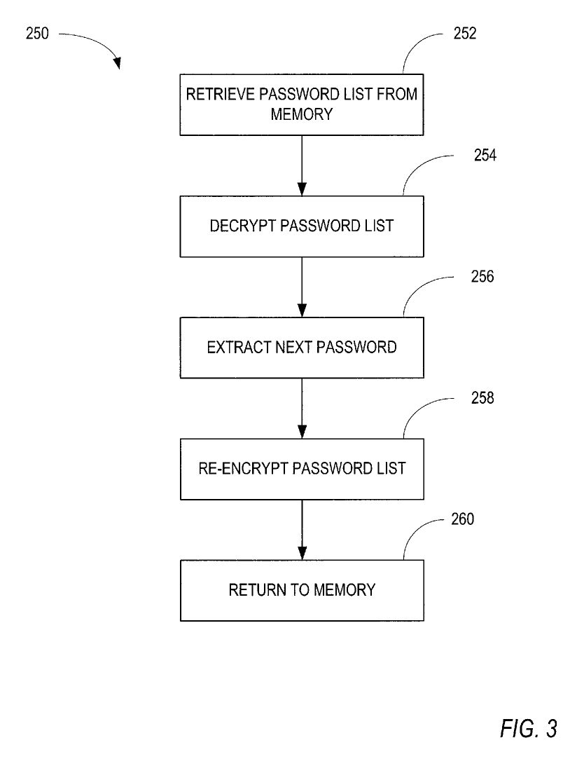

As noted earlier, the password list may be stored in a secure memory, such as a smart card. The smart card may further include a secure processor for encrypting/decrypting the password list, and for extracting passwords from the password list. FIG. 3 illustrates an exemplary procedure 250 executed by a secure processor in a smart card for selecting passwords from the password list. The process begins when the smart card receives a request for a password. The request may originate, for example, from an application in the mobile device 100. When the mobile device 100 needs to send a password to the home network 20, the password list is retrieved from memory (block 252). If the password list is encrypted, the password list is first decrypted (block 254). Following decryption of the password list, the next password is extracted from the password list (block 256). The smart card may output this password to the requesting application. The password list is then re-encrypted (block 258) and returned to secure memory (block 260). Note that because the decryption and decryption is carried out within a smart card or other secure device, it is difficult for a third party to discover the entire password list by making a fraudulent request.

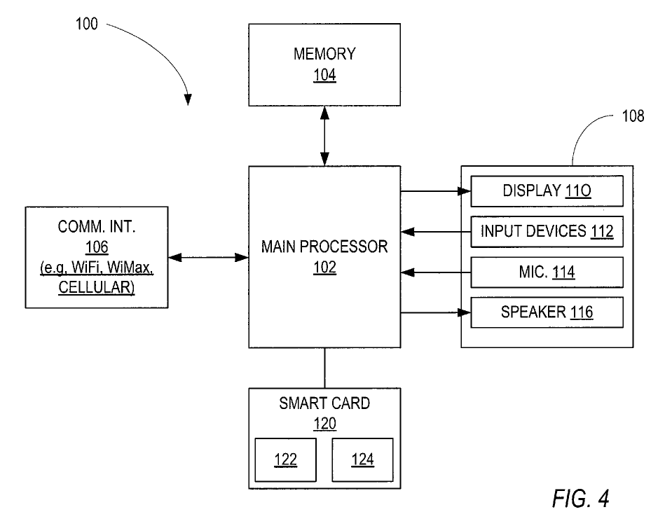

FIG. 4 illustrates an exemplary mobile device 100 for remotely accessing a home network 20. The mobile device 100 comprises a main processor 102 to control the overall operation of the mobile device 100 and to execute applications. Memory 104 stores applications, system data needed for operation, and user data. The mobile device 100 further includes one or more communication interfaces 106 for communicating with remote devices over various communication networks. The communication interfaces 106 may include a conventional wireless interface according to the 802.11 (WiFi) standards and/or 802.16 (WiMax) standards via a wireless access point. Additionally, communication interfaces 106 may include a conventional cellular transceiver. The cellular transceiver may use any known access technology, such as GPRS, WCDMA, OFDM, etc. The mobile device 100 further comprises a user interface 108. The user interface 108 includes a display 110, one or more input devices 112, a microphone 114, and speaker 116. Display 110 outputs information for viewing by the user and the input devices 112 receive the user's input. The input devices 112 may comprise, for example, a keyboard, keypad, scroll wheel, touch pad, and/or trackball. A touch screen display may also be used as an input device 112. The microphone 114 converts audible sounds into audio data for input to the main processor. Speaker 116 converts audio signals output by the processor 102.

In a preferred embodiment, the mobile device 100 further includes a tamperproof smart card 120 or other secure device having a secure memory 122 and secure processor 124. The secure memory 122 stores the password list and the secure processor 124 extracts the password from the password list as previously described responsive to a request from an application executed by the main processor 102. When a password is requested, the secure processor 124 may request a valid user name and password before responding to the request to provide an additional layer of security in the event that the mobile device 100 falls into the hands of a malicious third party.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of securely accessing a trusted network over of wide area network by a mobile device, said method comprising:
connecting to said trusted network via a secure connection;
receiving a password list containing a plurality of one-time passwords from said trusted network at said mobile device while said mobile device is connected to said trusted network via said secure connection;
storing said password list in said mobile device;
subsequently connecting remotely to said trusted network over a wide area network; and
sending a selected one-time password from said password list to access network resources in said trusted network.

2. The method of claim 1 wherein securely connecting to said trusted network comprises connecting to said trusted network via a local access point.

3. The method of claim 1 wherein said password list comprises a random or pseudorandom bit sequence and wherein said mobile device selects a password from said password list based on a predetermined bit selection algorithm.

4. The method of claim 1 further comprising encrypting said one-time password before sending said one-time password to said trusted network.

5. The method of claim 1 wherein storing said password list comprises storing said password list in protected memory in said mobile device.

6. The method of claim 1 wherein storing said password list comprises storing said password list in encrypted form in memory in said mobile device.

7. The method of claim 1 wherein said trusted network comprises a home network.

8. A mobile device for securely accessing a trusted network over of wide area network, said mobile device comprising:
a communication interface for connecting to said trusted network via a secure connection at a first point in time and for subsequently connecting to said trusted network via a WAN at a second point in time;
a processor configured to receive a password list containing a plurality of one-time passwords from said trusted network while said mobile device is connected to said trusted network via said local access point, and to send a selected one-time password from said password list to access network resources in said trusted network when subsequently connecting to said trusted network via the WAN at the second point in time to gain access to network resources; and
memory for storing said password list.

9. The mobile device of claim 8 wherein said secure connection comprises a local access point in said trusted network.

10. The mobile device of claim 8 further comprising a secure memory to store said password list and a secure processor configured to select a one-time password from said password list when requested by an application.

11. The mobile device of claim 8 wherein said password list comprises a random or pseudorandom bit sequence and wherein said processor selects said password from said password list based on a predetermined bit selection algorithm.

12. The mobile device of claim 8 wherein said one-time password is encrypted before sending said one-time password to said trusted network.

13. The mobile device of claim 8 wherein said password list is stored in encrypted form in said memory.

14. The mobile device of claim 8 wherein said trusted network comprises a home network.
